(19) United States
(12) Patent Application Publication
(10) Pub. No.: US 2021/0058527 A1
(43) Pub. Date: Feb. 25, 2021

(54) IMAGE PROCESSING APPARATUS, IMAGE PROCESSING METHOD, AND NON-TRANSITORY RECORDING MEDIUM

(71) Applicant: TOSHIBA TEC KABUSHIKI KAISHA, Tokyo (JP)

(72) Inventor: Shigeo Uchida, Mishima Shizuoka (JP)

(21) Appl. No.: 16/544,960

(22) Filed: Aug. 20, 2019

(51) Int. Cl. H04N 1/00

(52) U.S. Cl. CPC H04N 1/00938; H04N 2201/0094; H04N 1/00954

(57) ABSTRACT

According to one embodiment, an image processing apparatus includes an image processing unit, a controller, and a storage unit. The image processing unit is configured to process an image. The controller configured to execute an application program relating to the process of the image. The storage unit is configured to store the application program that is installed in the image processing apparatus and a to-be-used program that is a program to be used by the application program. At the time of update of the to-be-used program, the controller reinstalls an application program that satisfies a predetermined condition between a version of the updated to-be-used program and a version of the installed application program.

### FIELD

Embodiments described herein relate generally to an image processing apparatus, an image processing method, and a non-transitory recording medium.

### BACKGROUND

An image processing apparatus executes image processing such as formation of an image in accordance with a program. The program of the image processing apparatus includes an MFP (Multifunctional Printer) function program and an application program that have different versions depending on image processing apparatuses. The MFP function program is a program using an operating system. The application program is a program using the MFP function program. However, the program of the image processing apparatus maybe installed by a worker. In this case, the MFP function program or the application program varies depending on image processing apparatuses. Therefore, the worker is required to install the program after checking the version of the program before installation. This way, the worker feels a burden in that the worker needs to check the version before installing the program.

### DESCRIPTION OF THE DRAWINGS

FIG. 1 is an appearance diagram illustrating an overall configuration example of an image processing apparatus 100 according to an embodiment;

FIG. 2 is a block diagram illustrating an example of a functional configuration of the image processing apparatus 100 according to the embodiment;

FIG. 3 is a flowchart illustrating an example of the flow of processes that are executed by a controller 40 according to the embodiment;

FIG. 4 is a diagram illustrating an example of a determination result of the controller 40 on whether or not to be a reinstall candidate according to the embodiment;

FIG. 5 is a diagram illustrating an example of a functional configuration of an image processing system 1 according to a modification example; and

FIG. 6 is a flowchart illustrating an example of the flow of processes that are executed by the image processing system 1.

### DETAILED DESCRIPTION

In general, according to one embodiment, an image processing apparatus includes an image processing unit, a controller, and a storage unit. The image processing unit is configured to process an image. The controller configured to execute an application program relating to the process of the image. The storage unit is configured to store the application program that is installed in the image processing apparatus and a to-be-used program that is a program to be used by the application program. At the time of update of the to-be-used program, the controller reinstalls an application program that satisfies a predetermined condition between a version of the updated to-be-used program and a version of the installed application program.

Hereinafter, an image processing apparatus, an image processing method, and a non-transitory recording medium according to an embodiment will be described with reference to the drawings.

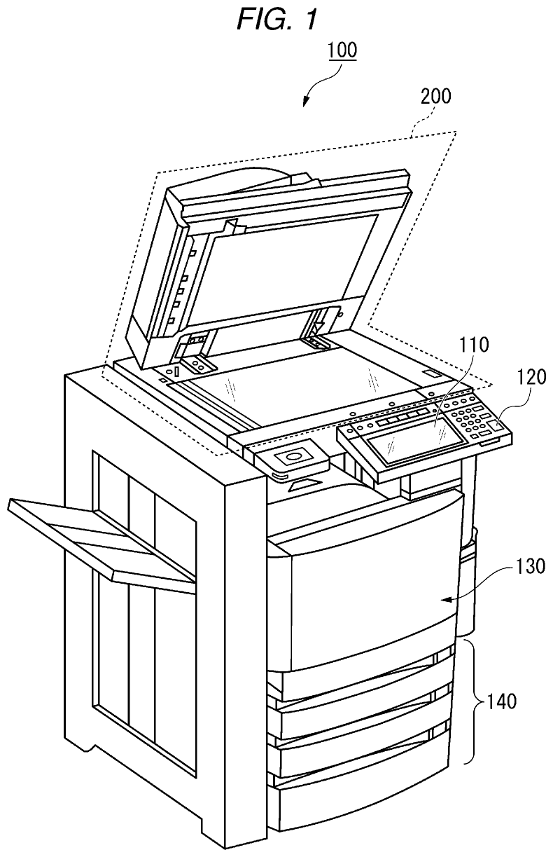

FIG. 1 is an appearance diagram illustrating an overall configuration example of an image processing apparatus 100 according to the embodiment. The image processing apparatus 100 is an image forming apparatus such as a multi-function peripheral. The image processing apparatus 100 includes a display 110, a control panel 120, a printer 130, a sheet accommodation unit 140, and an image reading unit 200. The printer 130 in the image processing apparatus 100 may be a device that fixes a toner image or an ink jet device.

The image processing apparatus 100 reads an image formed on the sheet to generate digital data and generates an image file using the digital data. The sheet may be, for example, paper on which an original document, a character, an image, or the like is printed. The sheet may be any material as long as it is a material that can be read by the image processing apparatus 100.

The display 110 is an image display device such as a liquid crystal display or an organic EL (Electro Luminescence) display. The display 110 displays various types of information relating to the image processing apparatus 100.

The control panel 120 includes a plurality of buttons. The control panel 120 receives the operation of a user. In addition, the control panel 120 outputs a signal corresponding to the operation input by the user to a controller of the image processing apparatus 100. The display 110 and the control panel 120 maybe configured to be integrated into a touch panel.

The printer 130 forms an image on the sheet based on image information generated by the image reading unit 200 or image information received through a communication path. The printer 130 forms an image through, for example, the following process. An image forming unit of the printer 130 forms an electrostatic latent image on a photoconductive drum based on the image information. The image forming unit of the printer 130 applies a developer to the electrostatic latent image to form a visible image. Specific examples of the developer include toner. A transfer unit of the printer 130 transfers the visible image to the sheet. The fixing unit of the printer 130 applies heat and pressure to the sheet to fix the visible image to the sheet. The sheet on which the image is formed may be a sheet accommodated in the sheet accommodation unit 140 or a sheet that is manually fed.

The sheet accommodation unit 140 accommodates the sheet used for forming the image in the printer 130.

The image reading unit 200 reads image information of a reading target in the form of brightness of light. The image reading unit 200 records the read image information. The recorded image information may be transmitted to another information processing apparatus through a network. Based on the recorded image information, the printer 130 may form an image on the sheet.

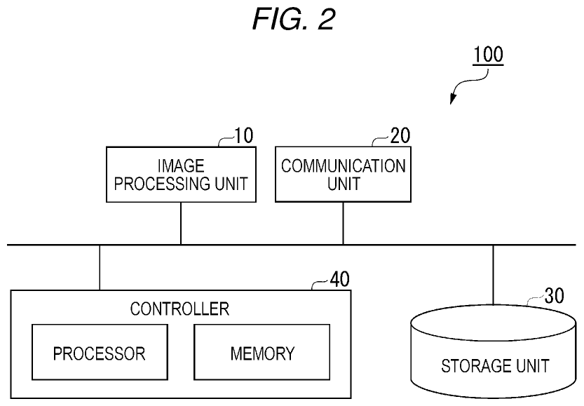

FIG. 2 is a block diagram illustrating an example of a functional configuration of the image processing apparatus 100 according to the embodiment. The image processing apparatus 100 includes an image processing unit 10, a communication unit 20, a storage unit 30, and a controller 40.

The image processing unit 10 operates in accordance with the control of the controller 40. The image processing unit 10 processes an image. For example, the image processing unit 10 includes a developing unit, a plurality of primary transfer rollers, a secondary transfer unit, and an exposure unit. For example, the image processing unit 10 operates as follows. The exposure unit of the image processing unit 10 forms an electrostatic latent image on the photoconductive drum based on the image information as an image formation target. The developing unit of the image processing unit 10 applies the developer to the electrostatic latent image to form a visible image. The primary transfer roller of the image processing unit 10 transfers the formed visible image to an image carrier. The secondary transfer unit of the image processing unit 10 transfers the visible image formed on the image carrier to the sheet.

The communication unit 20 acquires an MFP function program. The MFP function program is a program using an OS (Operating System). The MFP function program is, for example, a program that controls the reading of the sheet or the transfer to the sheet. The communication unit 20 acquires information (hereinafter, referred to as “MFP function version information”) representing a version of the MFP function program. The communication unit 20 acquires the application program. The application program is a program relating to the process of the image. The application program is a program using the MFP function program. The application program is, for example, a program that controls storage of an image formed by reading the sheet in the storage unit 30. The communication unit 20 acquires information (hereinafter, referred to as “application related information”) relating to the application program. The application related information includes information (hereinafter, referred to as “application version information”) representing a version of the application program. The application related information includes information (hereinafter, referred to as “support MFP function information”) representing a version of an MFP function program that satisfies a predetermined condition relating to an operation of the application program. Hereinafter, the predetermined condition relating to an operation of the application program will be referred to as “application operation condition”. The application operation condition is, for example, a condition where the application program operates using the MFP function program. The application related information includes information (hereinafter, referred to as “application name information”) representing a name of the application program. The communication unit 20 is configured to include a communication interface for connecting the image processing apparatus to an external apparatus. The communication unit 20 communicates with the external apparatus through a wired or wireless connection. The communication unit 20 acquires the MFP function program and the MFP function version information that are transmitted from the external apparatus as a communication destination. The communication unit 20 acquires the application program and the application related information that are transmitted from the external apparatus as a communication destination. The communication unit 20 may acquire the MFP function program from the external storage device such as a USB.

The storage unit 30 is configured using a storage device such as a magnetic hard disk device or a semiconductor memory device. The storage unit 30 stores various control programs including the OS, the MFP function program, and the application program. The storage unit 30 stores the MFP function version information and the application related information.

The controller 40 is configured using a processor such as a CPU (Central Processing Unit) or a memory. The controller 40 operates by executing various control programs including the OS, the MFP function program, and the application program. The controller 40 controls the operation of the image processing apparatus 100 by executing the control programs. The controller 40 controls the image processing unit 10 such that an image is processed. The controller 40 controls the image processing unit 10 such that a visible image representing an image designated by the user is formed on the sheet. The controller 40 updates the MFP function program. Specifically, the update of the MFP function program represents installation of a new MFP function program instead of the installed MFP function program. The MFP function program is installed by executing the OS. The MFP function program is not necessarily installed by executing the OS and may be installed by the operation of the user.

The controller 40 reinstalls the application program. The reinstallation refers to overwrite installation. For example, during the reinstallation, the installed MFP function program is associated with a function that is executable by the installed MFP function program among functions of an application program to be reinstalled. The result of the association is recorded in the storage unit 30, for example, as data such as a setting file. During the reinstallation, the overwrite installation is executed without uninstalling the application program that is installed in advance. That is, data of the application program that is installed in advance is not deleted from the storage unit 30. The application program is reinstalled by executing the OS. The application program is not necessarily reinstalled by executing the OS and may be reinstalled by the MFP function program. The controller 40 restarts the image processing apparatus 100 after the installation of the MFP function program.

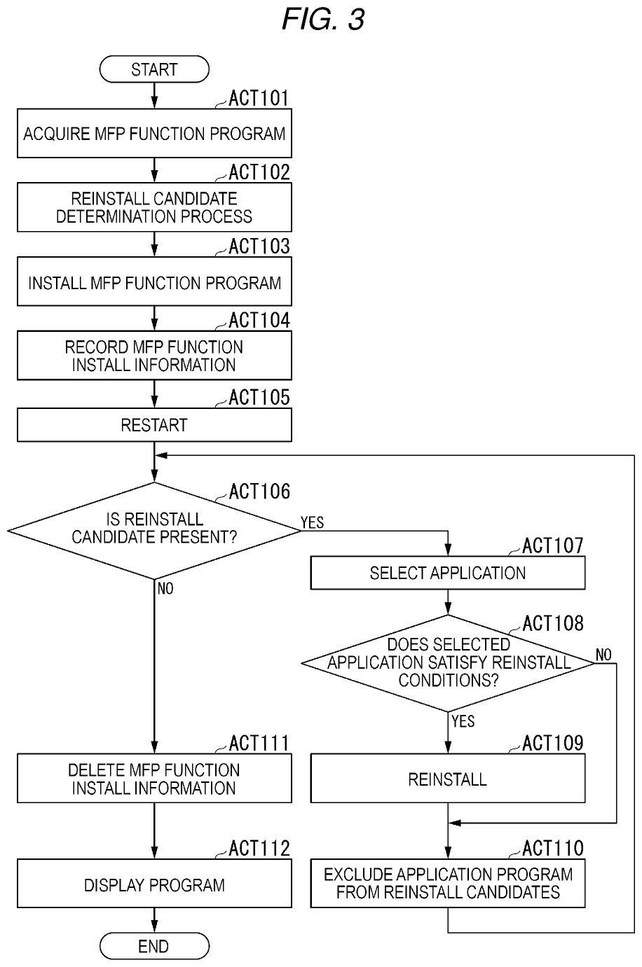

FIG. 3 is a flowchart illustrating an example of the flow of processes that are executed by the controller 40 according to the embodiment.

The controller 40 acquires the MFP function program and the MFP function version information (ACT 101). The controller 40 determines an application program that satisfies a reinstall candidate condition among the installed application programs based on the MFP function version information acquired in ACT 101 (ACT 102). The reinstall candidate condition is a predetermined condition relating to the reinstallation of the application program. The reinstall candidate condition is, for example, a condition that the version represented by the MFP function version information acquired in ACT 101 is included in the version represented by the support MFP function information. In ACT 102, specifically, whether or not each of the installed application programs satisfies the reinstall candidate condition is determined. Hereinafter, the process of ACT 102 will be referred to as “reinstall candidate determination process”. The MFP function program acquired in ACT 101 is installed (ACT 103). ACT 103 represents the MFP function program installed in the image processing apparatus 100 is updated. The controller 40 records information (hereinafter, referred to as “MFP function install information”) representing that the MFP function program is installed in the storage unit 30 (ACT 104). The controller 40 restarts the image processing apparatus 100 (ACT 105).

The controller 40 determines whether or not a reinstall candidate is present (ACT 106). The reinstall candidate is an installed application program that is determined to satisfy the reinstall candidate condition in ACT 102. When the reinstall candidate is present (ACT 106: YES), the controller 40 selects a reinstall candidate that satisfies a predetermined condition (hereinafter, referred to as “execution order condition”) relating to the order of a reinstall execution determination process among the reinstall candidates (ACT 107). The reinstall execution determination process is a process that determines whether or not the installed application program satisfies a reinstall condition. The reinstall condition is a condition that the version of the MFP function program during the installation of the application program is older than the version of the updated MFP function program. The updated MFP function program refers to the MFP function program acquired in ACT 101. The execution order condition is a condition based on the name of the application program. The execution order condition is, for example, a condition that application programs not having undergone the reinstall execution determination process are executed in order from an application program having a name closest to “the first letter” in the Japanese syllabary order (hereinafter, referred to as “Japanese syllabary order condition”). The execution order condition is, for example, a condition that application programs not having undergone the reinstall execution determination process are executed in order from an application program having a name closest to “A” in the alphabetical order. The execution order condition is, for example, a condition that application programs not having undergone the reinstall execution determination process are executed in order of previous reinstallation (hereinafter, referred to as “previous reinstallation condition”).

The controller 40 executes the reinstall execution determination process on the reinstall candidate selected in ACT 107 (ACT 108). When the application program satisfies the reinstall condition (ACT 108: YES), the controller 40 reinstalls the application program (ACT 109). The controller 40 executes a process excluding the reinstalled application program from the reinstall candidates (ACT 110). The application program excluded from the reinstall candidates is not the reinstall candidate anymore. After ACT 110, the process returns to ACT 106. On the other hand, when the application program does not satisfy the reinstall condition in ACT 108 (ACT 108: NO), the process of ACT 109 is not executed, but the process of ACT 110 is executed.

On the other hand, when the reinstall candidate is not present in ACT 106 (ACT 106: NO), the controller 40 deletes the MFP function install information stored in the storage unit 30 (ACT 111). After ACT 111, the reinstalled application program is displayed on the display 110 in order of reinstallation (ACT 112).

The processes from ACT 106 to ACT 111 are executed at a timing, for example, at the time of the update of the MFP function program. The time of the update of the MFP function program is a period from the installation of the MFP function program to execution of the installed application program. Specifically, the time of the update of the MFP function program is a period before the execution of the installed application program after the execution of the process of ACT 105.

The display 110 displays the application program in order of reinstallation. Therefore, it is preferable that the execution order condition is a condition where the application program displayed on the display 110 can be easily recognized by the user. For example, when the execution order condition is the Japanese syllabary order condition, the user can easily recognize the reinstalled application program. In addition, when the execution order condition is the previous reinstallation condition, whether or not the application program is reinstall in order from an application program that is most frequently used by the user can be checked. Therefore, when the execution order condition is the previous reinstallation condition, the user can easily recognize the reinstalled application program.

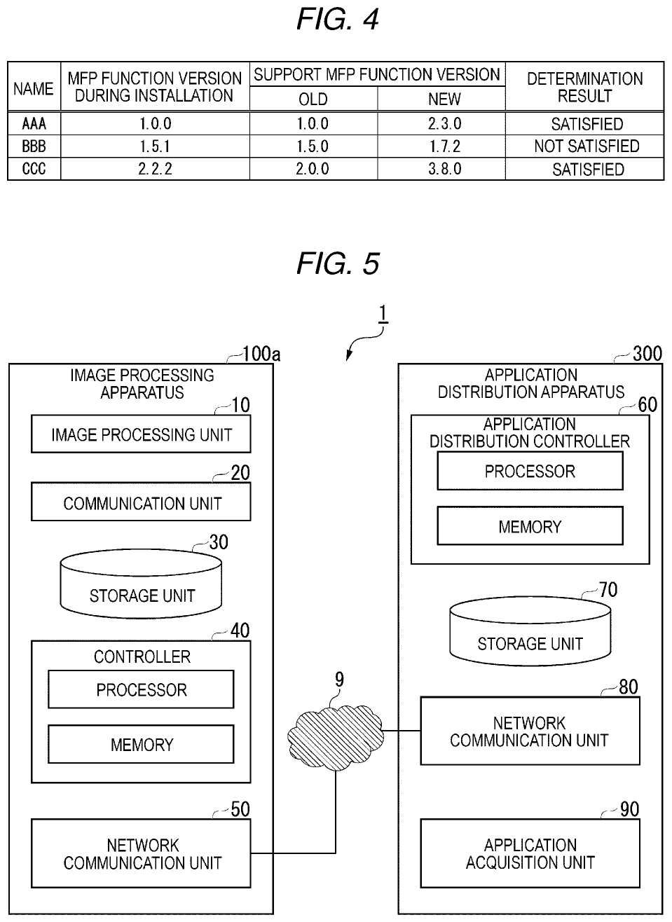

FIG. 4 is a diagram illustrating an example of a determination result of the controller 40 on whether or not to be the reinstall candidate according to the embodiment. Regarding the determination result illustrated in FIG. 4, the version of the MFP function program acquired in ACT 101 is 2.2.3. Each of cells in the column “Name” of FIG. 4 shows the name of the installed application program. Each of cells in the column “MFP Function Program during Installation” of FIG. 4 shows the version of the MFP function program during the installation of the installed application program. Each of cells in the column “Support MFP Function Version” of FIG. 4 shows the support MFP function information of the installed application program. In FIG. 4, the support MFP function information shows a range of the version of the MFP function program that satisfies the application operation condition. Each of cells of the column “Determination Result” of FIG. 4 shows the determination result of the controller 40 on whether or not to satisfy the reinstall condition.

For example, FIG. 4 shows that, regarding an application program having the name “AAA”, the version of the MFP function program during installation is 1.0.0. For example, FIG. 4 shows that, regarding the application program having the name “AAA”, the version of the MFP function program that satisfies the application operation condition is 1.0.0 to 2.3.0. For example, FIG. 4 shows that the application program having the name “AAA” is an application program that satisfies the reinstall condition.

For example, FIG. 4 shows that, regarding an application program having the name “BBB”, the version of the MFP function program during installation is 1.5.1. For example, FIG. 4 shows that, regarding the application program having the name “BBB”, the version of the MFP function program that satisfies the application operation condition is 1.5.0 to 1.7.2. For example, FIG. 4 shows that the application program having the name “BBB” is an application program that does not satisfy the reinstall condition.

The image processing apparatus 100 having the above-described configuration includes the controller 40 that installs the application program satisfying the reinstall condition before starting the application program even after the installation of the MFP function program. Therefore, the image processing apparatus 100 can reduce a burden of a worker for the installation of the programs.

### MODIFICATION EXAMPLE

The storage unit 30 may store, per application program, information representing the version of the MFP function program when each of the application programs is installed. Hereinafter, the information representing the version of the MFP function program when the application program is installed is the MFP function version information during installation. In this case, the reinstall candidate condition may be a condition that the version of the MFP function program acquired in ACT 101 is newer than the version representing the MFP function version information during installation.

The support MFP function information does not necessarily represent only a plurality of continuous versions. The support MFP function information may represent only one version. The support MFP function information may represent a plurality of discontinuous versions.

FIG. 5 is a diagram illustrating an example of a functional configuration of an image processing system 1 according to a modification example. The image processing system 1 includes an image processing apparatus 100a and an application distribution apparatus 300. The image processing apparatus 100a is different from the image processing apparatus 100 in that it further includes a network communication unit 50 in addition to the image processing unit 10, the communication unit 20, the storage unit 30, and the controller 40. The image processing unit 10, the communication unit 20, the storage unit 30, the controller 40, and the network communication unit 50 are connected through a bus. In FIG. 5, the same functional units as those included in the image processing apparatus 100 are represented by the same reference numerals in FIGS. 1 and 2, and the description thereof will not be repeated.

The network communication unit 50 is configured to include a communication interface for communicating with the image processing apparatus 100a and the application distribution apparatus 300. The network communication unit 50 communicates the application distribution apparatus 300 through a wired or wireless connection. The network communication unit 50 receives the application program that is transmitted from the application distribution apparatus 300 through a network 9. The application program received by the network communication unit 50 is stored in the storage unit 30.

The application distribution apparatus 300 includes an application distribution controller 60 including a processor such as a CPU and a memory that are connected through a bus and executes a program. Depending on the programs to be executed, the application distribution apparatus 300 functions as an apparatus including the application distribution controller 60, a storage unit 70, a network communication unit 80, and an application acquisition unit 90.

The application distribution controller 60 controls the operation of each of the functional units in the application distribution apparatus 300. The storage unit 70 is configured using a storage device such as a magnetic hard disk device or a semiconductor memory device. The storage unit 70 stores the application program and information of the version of the application program.

The network communication unit 80 is configured to include a communication interface for communicating with the image processing apparatus 100a and the application distribution apparatus 300. The network communication unit 80 communicates with the image processing apparatus 100a through a wired or wireless connection. The network communication unit 80 operates in accordance with the control of the application distribution controller 60. The network communication unit 80 transmits the application program stored in the storage unit 70 to the image processing apparatus 100a through the network 9. The application acquisition unit 90 is configured to include a communication interface through which the application distribution apparatus 300 and an external apparatus that transmits the application program to the application distribution apparatus 300 communicate with each other. The application acquisition unit 90 acquires the application program through the communication interface. The application program acquired by the application acquisition unit 90 is recorded in the storage unit 70.

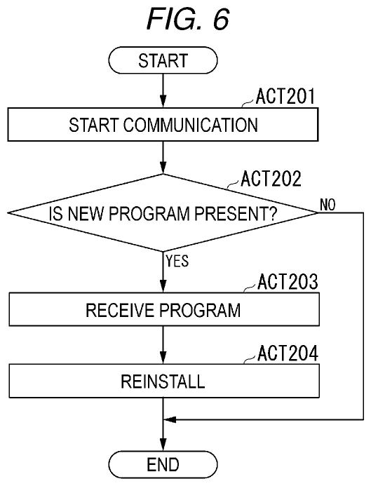

FIG. 6 is a flowchart illustrating an example of the flow of processes that are executed by the image processing system 1 according to the modification example. The processes of FIG. 6 are periodically repeated at predetermined time intervals. The processes of FIG. 6 may be executed at any timing as long as they are executed before executing the process of ACT 105 in FIG. 3.

The controller 40 of the image processing apparatus 100a starts communication with the application distribution apparatus through the network communication unit 50 (ACT 201). The controller 40 determines whether or not the application program that is installed in the image processing apparatus 100a is a program of which the version is updated (ACT 202). The program of which the version is updated is the application program of which the version is newer than the version of the installed application program.

When the program of which the version is updated is present (ACT 202: YES), the controller 40 of the image processing apparatus 100a receives the application program stored in the storage unit 70 through the network communication unit 50 (ACT 203). The controller 40 installs the received application program irrespective of the version of the MFP function program (ACT 204). Through the process of ACT 204, the application program installed in the image processing apparatus 100a is updated. On the other hand, in ACT 202, when the program of which the version is updated is not present (ACT 202: NO), the process ends.

In the image processing apparatus 100a having the above-described configuration, whether or not the reinstall candidate condition is satisfied when the application program having a new version is installed. In the image processing apparatus 100a having the above-described configuration, whether or not the reinstall condition is satisfied when the application program having a new version is installed is not determined. That is, in the image processing apparatus 100a, the application program having a new version is installed irrespective of the version of the MFP function program. Therefore, in the image processing apparatus 100a having the above-described configuration, a processing load for the installation of the application program of which the version is updated can be reduced.

The controller 40 of the image processing apparatus 100 and the controller 40 of the image processing apparatus 100a do not necessarily determine whether or not the reinstall candidate condition is satisfied. The controller 40 of the image processing apparatus 100 and the controller 40 of the image processing apparatus 100a do not necessarily determine whether or not the reinstall condition is satisfied. The controller 40 of the image processing apparatus 100 and the controller 40 of the image processing apparatus 100a may reinstall all the application programs every time the MFP function program is installed. The MFP function program is an example of the to-be-used program. The display 110 is an example of the display unit.

According to at least one of the above-described embodiments, the controller 40 is provided. As a result, a burden of a worker for the installation of the programs can be reduced.

Some or all of the respective functions of the image processing apparatus 100, the image processing apparatus 100a, and the application distribution apparatus 300 may be implemented by hardware such as an ASIC (Application Specific Integrated Circuit), a PLD (Programmable Logic Device), or a FPGA (Field Programmable Gate Array). The program may be recorded in a computer-readable recording medium. “Computer-readable recording medium” refers to a storage device, for example, a portable medium such as a flexible disk, a magneto-optic disk, a ROM, or a CD-ROM or a hard disk built into a computer system. The program may be transmitted through an electric telecommunication line.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An image processing apparatus, comprising:
a processor; and
a memory that stores instructions that, when executed by the processor, facilitate performance of operations, comprising:
processing an image;
executing an application program to process of the image; and
storing the application program that is installed in the image processing apparatus and a to-be-used program that is installed in the image processing apparatus, wherein the to-be-used program is to be used by the application program, and storing a version of the to-be-used program that satisfies an operation condition relating to an operation of the application program, wherein
at a time of an update of the to-be-used program, reinstalling the application program based on satisfying a predetermined condition between a version of an updated to-be-used program and a version of the application program, and
reinstalling the application program when version information data of the to-be-used program satisfies the operation condition of the application program and includes the version of the updated to-be-used program.

2. The apparatus according to claim 1, wherein the operations further comprising:
reinstalling the application program when the version of the updated to-be-used program is in a predetermined range and the version of the installed application program during installation is older than the version of the updated to-be-used program.

3. The apparatus according to claim 1, wherein the operations further comprising:
reinstalling the application program when the version of the updated to-be-used program is in a predetermined version and the version of the installed application program during installation is older than the version of the updated to-be-used program.

4. The apparatus according to claim 1, wherein the operations further comprising:
installing the application program having a newer version than the installed application program irrespective of the version of the to-be-used program.

5. The apparatus according to claim 1, wherein
the time of the update of the to-be-used program is a period from the installation of the to-be-used program to execution of the installed application program.

6. The apparatus according to claim 1, wherein the operations further comprising:
displaying the reinstalled application program in order of reinstallation of the application program.

7. The apparatus according to claim 6, wherein
at the time of the update of the to-be-used program, the application program is installed according to a name of the application program in an alphabetical order.

8. The apparatus according to claim 6, wherein
at the time of the update of the to-be-used program, the application program is installed in order of previous installation of the application program.

9. An image processing method, comprising:
processing an image;
executing an application program relating to the process of the image; and
storing the application program that is installed in an image processing apparatus and a to-be-used program that is installed in the image processing apparatus, wherein the to-be-used program is to be used by the application program, and storing a version of the to-be-used program that satisfies an operation condition relating to an operation of the application program, wherein
at a time of an update of the to-be-used program, reinstalling the application program based on satisfying a predetermined condition between a version of an updated to-be-used program and a version of the application program, and
reinstalling the application program when version information data of the to-be-used program satisfies the operation condition of the application program and includes the version of the updated to-be-used program.

10. The method according to claim 9, further comprising:
reinstalling the application program when the version of the updated to-be-used program is in a predetermined range and the version of the installed application program during installation is older than the version of the updated to-be-used program.

11. The method according to claim 9, further comprising:
reinstalling the application program when the version of the updated to-be-used program is in a predetermined version and the version of the installed application program during installation is older than the version of the updated to-be-used program.

12. The method according to claim 9, further comprising:
installing the application program having a newer version than the installed application program irrespective of the version of the to-be-used program.

13. The method according to claim 9, wherein
the time of the update of the to-be-used program is a period from the installation of the to-be-used program to execution of the installed application program.

14. The method according to claim 9, further comprising:
displaying the reinstalled application program in order of reinstallation of the application program.

15. The apparatus according to claim 14, further comprising:
at the time of the update of the to-be-used program, installing the application program according to a name of the application program in an alphabetical order.

16. The apparatus according to claim 14, further comprising:
at the time of the update of the to-be-used program, installing the application program in order of previous installation of the application program.

17. A non-transitory recording medium that stores a program for allowing a computer as the image processing apparatus according to claim 1 to function.

18. The non-transitory recording medium according to claim 17, wherein
the time of the update of the to-be-used program is a period from the installation of the to-be-used program to execution of the installed application program.
